(19) United States
(12) Patent Application Publication
(10) Pub. No.: US 2008/0117477 A1
(43) Pub. Date: May 22, 2008

(54) FACSIMILE APPARATUS AND CONTROL METHOD THEREFOR

(75) Inventor: Shunichi Fujise, Abiko-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/940,916

(22) Filed: Nov. 15, 2007

(30) Foreign Application Priority Data
Nov. 22, 2006 (JP) 2006-315450

(51) Int. Cl. H04N 1/32

(52) U.S. Cl. 358/468

(57) ABSTRACT

A facsimile apparatus performs facsimile communication with a partner apparatus using a first communication path including a public line or a second communication path not including the public line, detects whether facsimile communication using the first communication path and facsimile communication using the second communication path are in contention with each other, selects which of facsimile communication using the first communication path and facsimile communication using the second communication path is to be given priority in the case where it is detected that facsimile communication using the first communication path and facsimile communication using the second communication path are in contention with each other, and gives priority to facsimile communication selected from facsimile communication using the first communication path and facsimile communication using the second communication path.

### BACKGROUND OF THE INVENTION

1. Field of the Invention

The present invention relates to a facsimile apparatus configured to perform facsimile communication with a partner apparatus, and more particularly, to a communication control operation on facsimile communication with a plurality of partner apparatuses in contention with one another.

2. Description of the Related Art

Known facsimile apparatuses are capable of performing facsimile communication in which image data is transmitted/received by establishing connections to a public line using modems (hereinafter referred to as “G3 FAX communication”). Specifically, the facsimile apparatuses transmit/receive image data using a protocol in compliance with the International Telecommunication Union-Telecommunication Standardization Sector (hereinafter abbreviated as “ITU-T”) Recommendation T.30 by using modems which are configured to process analog signals and support, for example, the ITU-T Recommendation V.8/V.34 or V.17.

In the recent years, the facsimile apparatuses can further perform real-time Internet facsimile communication via the Internet or a local area network (LAN) (hereinafter referred to as “internet protocol (IP)-FAX communication”). Specifically, the facsimile apparatuses use a protocol in compliance with the ITU-T Recommendation T.38 to convert image data into Internet facsimile protocol (IFP) packets and transmit/receive the packets to/from a partner apparatus or a gateway apparatus.

A facsimile apparatus connected to the public line and a LAN has both the foregoing IP-FAX communication function and the G3 FAX communication function. In such a case, IP-fax communication and G3 FAX communication may be performed in parallel to each other with different communication apparatuses.

In known G3 FAX communication via the public line, one-to-one communication is performed between a transmitting apparatus and a receiving apparatus by performing call/connection with a partner apparatus. In contrast, IP-FAX communication allows a facsimile apparatus to perform communication with a plurality of partner apparatuses in parallel to one another, although call/connection is performed with each partner apparatus.

In the case where communication is performed with a plurality of apparatuses in parallel, there is a problem in that the load on a central processing apparatus (CPU), for example, configured to process data for facsimile communication is increased, resulting in a delay in data processing such as encoding/decoding. This delay may elongate the interval between signals to a length greater than or equal to the maximum time preset as a timer control value, leading to a communication break.

In order to solve this problem in that the communication is broken due to an increase in the signal interval to a length greater than or equal to the timer value, for example, in the case where IP-FAX communication is performed via an IP network, the timer value may be set to a large value.

In the case where communication is performed via an IP network, it is likely that a signal delay will occur due to the distance between communication points or line congestion, and hence the timer value is set to a large value in order to avoid a communication break even in the case of some delay (for example, see Japanese Patent Laid-Open No. 2003-87489).

However, in the case where the above-described IP-FAX communication and G3 FAX communication are in contention with each other or in the case where contention occurs due to IP-FAX communication with a plurality of apparatuses, the foregoing problems remain unsolved by the above-described related art.

That is, in the case where a facsimile apparatus capable of performing both IP-FAX communication and G3 FAX communication performs IP-FAX communication and G3 FAX communication in parallel to each other, the IP-FAX communication processing and the G3 FAX communication processing are in contention with each other, possibly resulting in a delay in data processing.

Even in the case of such a delay in data processing, if a timer control value has been set in advance to a large value as described in the above related art, a break in IP-FAX communication is avoided even in the case of some delay.

However, a timer value in G3 FAX communication is strictly defined in a standard such as the ITU-T Recommendation T.30 and cannot be changed. If a delay occurs in data processing such as encoding/decoding, G3 FAX communication will be broken.

Even in the case of IP-FAX communication, if a communication path between a transmitting apparatus and a receiving apparatus includes the public line, both the IP-FAX communication and G3 FAX communication may be performed using a gateway apparatus. In such a case, a signal delay due to a delay in data processing may cause a break in G3 FAX communication.

Further, even if the timer value in IP-FAX communication has been set to a large value, the processing speed itself is fast in IP-FAX communication. If a delay occurs in data processing, the communication may be broken.

### SUMMARY OF THE INVENTION

The present invention provides a scheme for avoiding a break in communication even in the case of facsimile communication with a plurality of partner apparatuses in contention with one another by giving priority to facsimile communication with one partner apparatus.

According to an aspect of the present invention, a facsimile apparatus includes a communication unit configured to perform facsimile communication with at least one partner apparatus using a first communication path including a public line or a second communication path not including the public line, a detection unit configured to detect whether facsimile communication using the first communication path and facsimile communication using the second communication path are in contention with each other, a selection unit configured to select which of facsimile communication using the first communication path and facsimile communication using the second communication path is to be given priority in the case where the detection unit detects that facsimile communication using the first communication path and facsimile communication using the second communication path are in contention with each other, and a control unit configured to control and give priority to facsimile communication selected by the selection unit.

According to another aspect of the present invention, a facsimile apparatus includes a communication unit configured to perform facsimile communication with at least one partner apparatus, a determination unit configured to determine whether the at least one partner apparatus is connected to a public line or connected to the Internet or a local area network, a detection unit configured to detect, based on a determination result obtained by the determination unit, whether facsimile communication performed with a partner apparatus connected to the public line and facsimile communication performed with a partner apparatus connected to the Internet or a local area network are in contention with each other, and a control unit configured to control and give priority to facsimile communication performed with the partner apparatus connected to the public line in the case where the detection unit detects that facsimile communication performed with the partner apparatus connected to the public line and facsimile communication performed with the partner apparatus connected to the Internet or the local area network are in contention with each other.

Further functions of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 is a block diagram of the structure of a facsimile apparatus according to a first exemplary embodiment of the present invention.

FIG. 2 is a block diagram of the configuration of a system including the facsimile apparatus according to the first exemplary embodiment.

FIG. 3 illustrates an exemplary first control operation of the facsimile apparatus according to the first exemplary embodiment.

FIG. 4 illustrates an exemplary second control operation of the facsimile apparatus according to the first exemplary embodiment.

FIG. 5 illustrates an exemplary third control operation of the facsimile apparatus according to the first exemplary embodiment.

FIG. 6 illustrates a communication procedure using session initiation protocol (SIP) servers in the case of the facsimile apparatus according to the first exemplary embodiment.

FIG. 7 illustrates the contents of an INVITE message received by the facsimile apparatus illustrated in FIG. 1.

FIGS. 8A and 8B are flowcharts of an exemplary facsimile communication procedure performed by the facsimile apparatus according to the first exemplary embodiment.

FIG. 9 illustrates a memory map of a storage medium storing various data processing programs that can be read by a facsimile apparatus according to an embodiment of the present invention.

### DESCRIPTION OF THE EMBODIMENTS

Exemplary preferred embodiments of the present invention will now herein be described in detail below with reference to the drawings.

### Description of System Configuration

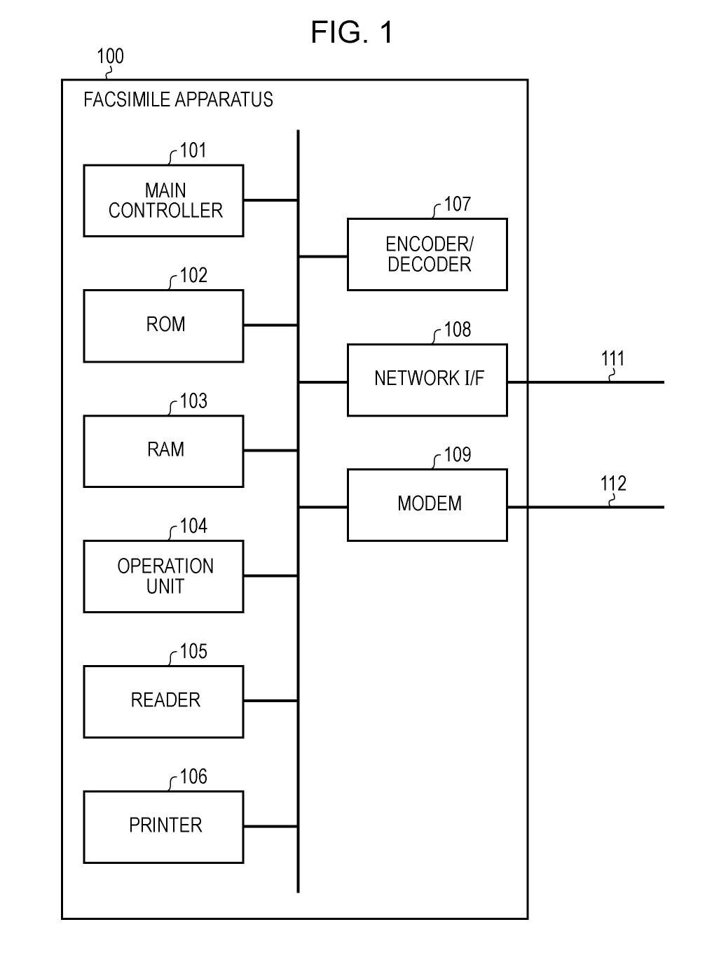

FIG. 1 is a block diagram of the structure of a facsimile apparatus 100 according to a first exemplary embodiment of the present invention.

In the facsimile apparatus 100 illustrated in FIG. 1, a main controller 101 controls the overall facsimile apparatus 100. A read-only memory (ROM) 102 stores a control program executed by the main controller 101.

The main controller 101 loads the control program onto a random-access memory (RAM) 103 and executes the control program, thereby controlling devices included in the facsimile apparatus 100.

The RAM 103 includes a dynamic RAM (DRAM), a static RAM (SRAM), or the like, and is used as a work area for a control operation performed by the main controller 101 or to temporarily store data, facsimile image data, or the like.

An operation unit 104 includes operation keys, an operation display panel, etc. A reader 105 reads an image of a document, converts the image into electronic data, and inputs the electronic data. A printer 106 records characters, photographs, etc., on recording paper.

An encoder/decoder 107 performs an encoding process of converting image data which has been read from a document and input by the reader 105 into data represented in an encoding format required for facsimile communication. Further, the encoder/decoder 107 performs a decoding process of decoding image data received in facsimile communication. Possible encoding formats used here include, for example, Modified Huffman (MH), Modified Read (MR), Modified Modified Read (MMR), and Joint Bi-level Experts Group (JBIG).

A network interface (I/F) 108 connects the facsimile apparatus 100 to a LAN 111, such as 100 Base T, and controls signal transmission/reception over the network. The LAN 111 is not limited to 100 Base T.

The LAN 111 is connected to the Internet. The facsimile apparatus 100 can perform communication via the Internet. In this case, the network I/F 108 can be controlled to perform IP-FAX communication in compliance with the ITU-T Recommendation T.38. That is, the main controller 101 controls the RAM 103, the network I/F 108, and the like to perform assembling/disassembling of IFP packets and transmission/reception of the packets.

A modem 109 connects the facsimile apparatus 100 to a public line 112 and performs data communication via the public line 112.

That is, a facsimile modem or a line connection control circuit supporting the ITU-T Recommendation V.8/V.34 or V.17 is used, and the main controller 101 controls the RAM 103, the modem 109, and the like to establish a connection with the public line 112 and perform G3 FAX communication with a partner apparatus.

Image data to be sent is read by the reader 105 or obtained via the network I/F 108. The obtained image data is encoded by controlling the RAM 103, the encoder/decoder 107, etc., and the encoded image data is sent via the modem 109.

In contrast, reception in G3 FAX communication involves a reception operation of the modem 109. Data received is decoded by controlling the RAM 103, the encoder/decoder 107, etc., and the decoded data is printed by the printer 106 or sent to another apparatus via the network I/F 108.

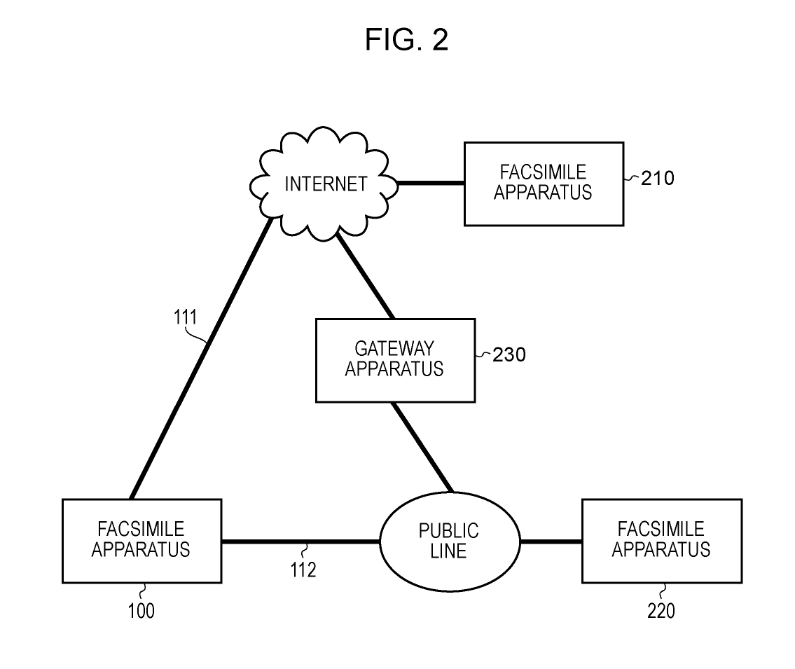

FIG. 2 illustrates an overall system including the facsimile apparatus 100. The facsimile apparatus 100 can perform IP-FAX communication with a facsimile apparatus 210 connected to the Internet via the LAN 111 (communication path A). The facsimile apparatus 210 provides the same or similar functions as the facsimile apparatus 100 and is connected to the Internet directly or via a LAN. Further, the facsimile apparatus 210 may be connected to the public line, which is not illustrated in FIG. 2.

The facsimile apparatus 100 is connected to a facsimile apparatus 220 via the public line. The facsimile apparatus 100 can perform G3 FAX communication with the facsimile apparatus 220 via the public line (communication path B).

The facsimile apparatus 220 provides the same or similar functions as the facsimile apparatus 100 and is directly connected to the public line. Further, the facsimile apparatus 220 may be connected to a LAN or the Internet, which is not illustrated in FIG. 2.

The facsimile apparatus 100 is capable of performing communication with the facsimile apparatus 220 via a gateway apparatus 230 (communication path C). Specifically, the facsimile apparatus 100 performs IP-FAX communication with the gateway apparatus 230 via the Internet.

The gateway apparatus 230 conforms to the ITU-T Recommendation T.38 and is capable of converting IFP packets for IP-FAX communication, which are received from the facsimile apparatus 100, into facsimile signals for G3 FAX communication.

At the same time, the gateway apparatus 230 can conversely convert facsimile signals for G3 FAX communication, which are received from the facsimile apparatus 220, into IFP packets for use in IP-FAX communication. The gateway apparatus 230 performs G3 FAX communication with the facsimile apparatus 220 via the public line.

Further, the facsimile apparatus 100 can perform communication with the facsimile apparatus 210 via the gateway apparatus 230 (communication path D). Specifically, the facsimile apparatus 100 performs G3 FAX communication with the gateway apparatus 230 via the public line.

The gateway apparatus 230 conforms to the ITU-T Recommendation T.38 and is capable of converting facsimile signals for G3 FAX communication, which are received from the facsimile apparatus 100, into IFP packets for IP-FAX communication. In contrast, the gateway apparatus 230 can convert IFP packets for IP-FAX communication, which are received from the facsimile apparatus 210, into facsimile signals for use in G3 FAX communication. The gateway apparatus 230 performs IP-FAX communication with the facsimile apparatus 210 via the Internet.

In this manner, the communication paths C and D include both the Internet and the public line. Facsimile communication using the communication path C or D includes both IP-FAX communication and G3 FAX communication.

Next, a priority determining function of determining, in facsimile communication using a plurality of different communication paths in contention with one another, which communication path to give priority to will be described.

The above-mentioned priority is set in advance for each type of communication path before communication starts. In the case where facsimile communication using different communication paths is performed in contention with one another, communication that is given priority is performed with priority. Alternatively, in the case where facsimile communication using different communication paths is performed in contention with one another, which communication should be given priority is determined in accordance a condition described below, and the determined communication is performed with priority. In the following description, an exemplary case in which the priority is determined in advance prior to the start of communication will be described.

The facsimile apparatus 100 illustrated in FIG. 1 is capable of performing facsimile communication using four types of communication paths A to D, as has been described above. In this case, according to the present embodiment, the communication paths are classified into two types, that is, type 1 including the public line (namely, the communication paths B to D) and type 2 including no public line (namely, the communication path A).

### First Control Operation

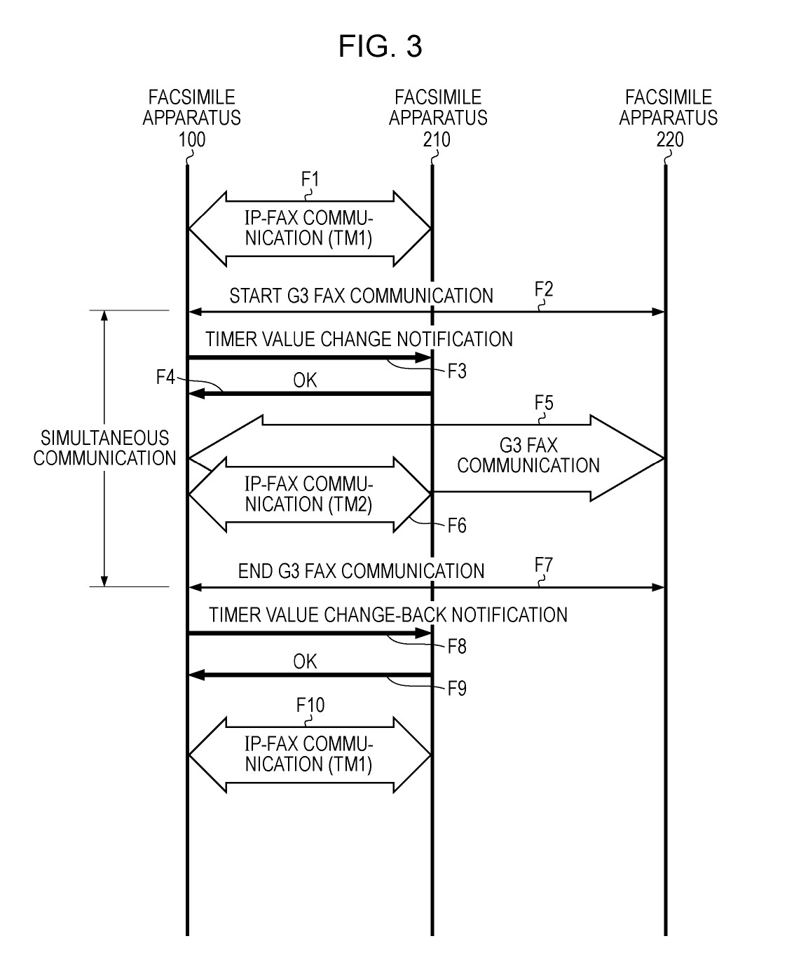

FIG. 3 illustrates a first control operation of the facsimile apparatus 100. In FIG. 3, the same components as those illustrated in FIG. 2 are denoted by the same reference numerals. Reference numerals F1 and F10 denote communication steps.

The first control operation described corresponds to the case in which, while the facsimile apparatus 100 is performing IP-FAX communication with the facsimile apparatus 210, the facsimile apparatus 100 starts performing G3 FAX communication with the facsimile apparatus 220. In this case, a control procedure is performed so that G3 FAX communication with the facsimile apparatus 220 has priority over IP-FAX communication with the facsimile apparatus 210.

Using the above-mentioned communication path A, the facsimile apparatus 100 is performing IP-FAX communication with the facsimile apparatus 210 via the Internet (F1). Here, it does not matter whether the communication is transmission from the facsimile apparatus 100 or from the facsimile apparatus 210. In this case, it is assumed that a timer control value in the IP-FAX communication is set to a normal value (TM1).

Thereafter, the facsimile apparatus 100 uses the above-mentioned communication path B to start performing G3 FAX communication with the facsimile apparatus 220 via the public line (F2).

Here, it does not matter whether the communication is transmission from the facsimile apparatus 100 or from the facsimile apparatus 220.

Since facsimile communication indicated in F2 has begun, the main controller 101 detects that facsimile communication using the type 2 communication path in use (F6) and facsimile communication using the type 1 communication path (F5) are performed in parallel, that is, in contention with each other.

Upon detection of the contention state, the main controller 101 controls the encoder/decoder 107 to give priority to the processing of data for use in facsimile communication using the type 1 communication path.

In this case, more resources including the RAM 103 are allocated to the processing including data encoding/decoding for G3 FAX communication with the facsimile apparatus 220. Accordingly, data processing can be performed without delay. That is, a signal delay is suppressed in G3 FAX communication with the facsimile apparatus 220, thereby avoiding a break in the communication.

In contrast, the facsimile apparatus 210 serving as a partner apparatus for IP-FAX communication is notified to change the timer control value used in IP-FAX communication.

This is because a delay may be caused in the processing of data used in IP-FAX communication with the facsimile apparatus 210 since the processing of data used in G3 FAX communication with the facsimile apparatus 220 is given priority.

By changing the timer control value in IP-FAX communication with the facsimile apparatus 210 to a larger value, a communication break is avoided even in the case of some delay in the data processing.

More specifically, the main controller 101 of the facsimile apparatus 100 controls and notifies the facsimile apparatus 210 to change the timer control value (F3). When the facsimile apparatus 210 becomes ready to accept the change of the timer control value, the facsimile apparatus 210 sends an affirmative response (OK) to the facsimile apparatus 100 (F4).

Accordingly, the facsimile apparatus 100 and the facsimile apparatus 210 change the timer control value to TM2, and perform IP-FAX communication.

The timer-control-value change notification in F3 and the affirmative response (OK) from the facsimile apparatus 210 in F4 are given by exchanging messages such as a digital identification signal (DIS; initial identification) or a digital command signal (DCS; reception command) or exchanging messages such as a non-standard facilities (NSF) signal or a non-standard set-up (NSS) signal.

The timer control value TM2 in F6 is generated by increasing the normal timer control value TM1 in IP-FAX communication to a larger value (TM1<TM2).

In the present embodiment, the normal timer control value TM1 is 35 seconds ±5 seconds, and the timer control value TM2 is set to, for example, three minutes. The value “three minutes” is set in accordance with the hardware resources such as the memory and CPU of the facsimile apparatus 100, and the timer control value TM2 is not limited to three minutes.

In contrast, instead of setting the timer control value TM2 to a specific value, the timer control may not be performed in IP-FAX communication. That is, the timer in IP-FAX communication is not counted, and facsimile communication may be performed by counting a transmission control protocol (TCP) connection timer.

In the first control operation, if facsimile communication using a communication path including the public line is in contention with facsimile communication using a communication path including no public line, the former (facsimile communication using a communication path including the public line) is given priority over the latter (facsimile communication using a communication path including no public line).

Accordingly, the first control operation controls and gives higher priority to the encoding/decoding of image data for G3 FAX communication with the facsimile apparatus 220, thereby enabling communication with the facsimile apparatus 210 and communication with the facsimile apparatus 220 in parallel to each other.

In F7, the facsimile apparatus 100 ends the facsimile communication with the facsimile apparatus 220. Thereafter in F8, the main controller 101 of the facsimile apparatus 100 notifies the facsimile apparatus 210 to change the timer control value TM2 back to TM1.

When the facsimile apparatus 210 becomes ready to accept the change of the timer value back to TIM1, the facsimile apparatus 210 sends in F9 an affirmative response (OK) in response to the timer-control-value change back notification to the facsimile apparatus 100. Thereafter in F10, the facsimile apparatus 100 and the facsimile apparatus 210 resume the IP-FAX communication in a state in which the timer control value has been changed back to TM1.

The timer-control-value change back notification and its affirmative response (OK) are given by exchanging messages such as an end of message (EOM) signal (Q signal), DIS, or DCS.

In the above description, the case has been described in which the facsimile apparatus 100 performs communication with the facsimile apparatus 220 using the communication path B as an example of the type 1 communication path including the public line.

However, even in the case where facsimile communication is performed using the communication path C or D instead of the communication path B, a similar control procedure is taken if the communication is in contention with facsimile communication using the communication path A.

More specifically, a control operation is performed so that the processing of data for facsimile communication using the communication path C or D is given priority over the processing of data for facsimile communication using the communication path A. Further, a control operation is performed to change the timer control value in facsimile communication (IP-FAX communication) using the communication path A to a larger value.

In the above description, one IP-FAX communication event is in contention with one G3 FAX communication event. However, more facsimile communication events may be in contention with one another.

Even in such a case, the processing of data for facsimile communication using a communication path including the public line may be performed with priority, and the timer control value in facsimile communication using a communication path including no public line may be changed.

### Second Control Operation

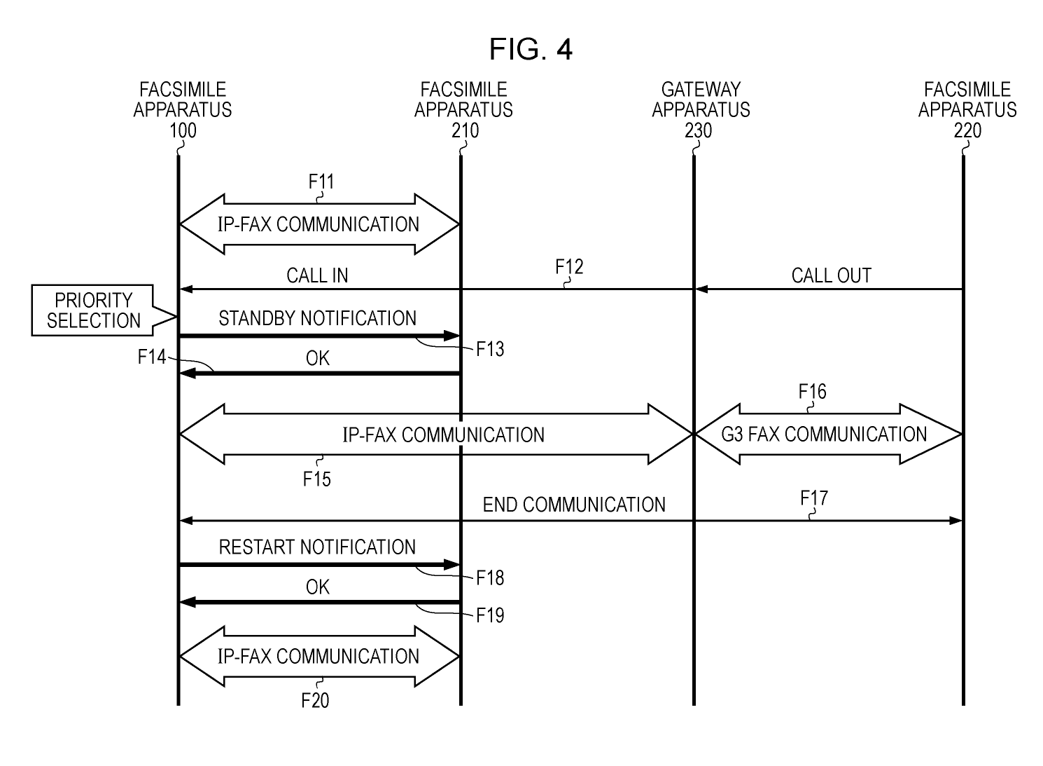

FIG. 4 illustrates a second control operation of the facsimile apparatus 100. The second control operation corresponds to the case where, while the facsimile apparatus 100 is communicating with the facsimile apparatus 210 using the communication path A, the facsimile apparatus 220 originates a call using the communication path C.

In FIG. 4, the same components as those illustrated in FIG. 2 are denoted by the same reference numerals. Reference numerals F11 and F20 denote communication steps. Using the above-mentioned communication path A, the facsimile apparatus 100 is performing IP-FAX communication with the facsimile apparatus 210 via the Internet (F11). Here, it does not matter whether the communication is transmission from the facsimile apparatus 100 or from the facsimile apparatus 210.

Upon receipt of a call from, for example, a SIP server, the facsimile apparatus 100 analyzes the contents of INVITE information and determines whether the partner apparatus is a gateway apparatus (F12).

In the case where the facsimile apparatus 100 determines that the partner apparatus is a gateway apparatus, it can be determined that the apparatus originating the call is connected to the public line, that is, the type 1 communication path is used in this communication. On the basis of the determination result, the main controller 101 can detect that facsimile communication using the type 1 communication path and facsimile communication using the type 2 communication path are in contention with each other.

Of a plurality of facsimile communication events in contention with one another, the facsimile apparatus 100 selects which facsimile communication event to give priority to. In this case, it is assumed that a priority table indicating that facsimile communication using the type 1 communication path has priority over facsimile communication using the type 2 communication path is set in advance on the RAM 103.

In this example, it has been registered in advance which of facsimile communication using the type 1 communication path and facsimile communication using the type 2 communication path is given priority. Alternatively, for example, the priority of each of the communication paths A to D may be registered in advance.

In the case where higher priority is given to facsimile communication using the type 1 communication path, facsimile communication with the facsimile apparatus 220 is performed with priority over facsimile communication with the facsimile apparatus 210.

Specifically in F13, the facsimile apparatus 100 notifies the facsimile apparatus 210 to enter a standby state. When the facsimile apparatus 210 becomes ready to accept the standby notification, the facsimile apparatus 210 sends in F14 an affirmative response (OK) to the facsimile apparatus 100, and IP-FAX communication between the facsimile apparatus 100 and the facsimile apparatus 210 enters a standby state.

The standby notification and its affirmative response (OK) are given by exchanging messages such as a DIS (initial identification) or DCS (reception command) or by exchanging messages such as an NSF or NSS signal.

In F15, the facsimile apparatus 100 performs IP-FAX communication with the gateway apparatus 230. In F16, the gateway apparatus 230 simultaneously performs G3 FAX communication with the facsimile apparatus 220.

Here, it does not matter whether the communication is transmission from the facsimile apparatus 100 or from the facsimile apparatus 220.

Accordingly, in the case where the facsimile apparatus 100 is performing facsimile communication with the facsimile apparatus 210, if it becomes necessary for the facsimile apparatus 100 to start facsimile communication with the different facsimile apparatus 220, the facsimile apparatus 100 places the facsimile communication with lower priority on standby. Accordingly, the resources including the main controller 101 and the encoder/decoder 107 can be allocated to the processing for facsimile communication with higher priority.

In particular, the processing including encoding/decoding of image data for facsimile communication with higher priority can be performed without delay, and hence facsimile communication can be performed without problems.

When the facsimile communication between the facsimile apparatus 100 and the facsimile apparatus 220 ends, the facsimile apparatus 100 and the facsimile apparatus 220 perform facsimile communication termination processing via the gateway apparatus 230 in F17.

That is, the facsimile apparatus 100 and the facsimile apparatus 220 exchange messages such as an end of packet (EOP; command after the message), a message confirmation (MCF; response after the message), DCN (disconnection command), or BYE in the SIP protocol.

Thereafter in step F18, the facsimile apparatus 100 notifies the facsimile apparatus 210 to restart the communication. When the facsimile apparatus 210 becomes ready to accept the restart notification, the facsimile apparatus 210 sends an affirmative response (OK) in F19 to the facsimile apparatus 100. In F20, the facsimile apparatus 100 and the facsimile apparatus 210 restart the IP-FAX communication.

The restart notification and its affirmative response (OK) may be given by exchanging messages such as an EOM (Q signal), DIS, or DCS.

According to the second control operation, the description concerns the case in which it has been set in advance on the RAM 103 that facsimile communication using the type 1 communication path has higher priority than that of facsimile communication using the type 2 communication path. However, in the case where facsimile communication using the type 2 communication path is given higher priority, a control procedure is performed to place communication with the facsimile apparatus 220 on standby.

That is, for example, a flow control procedure is performed using a transmitter not ready (TNR) signal or a receiver not ready (RNR) signal, and transmission/reception of image data is placed on standby.

### Third Control Operation

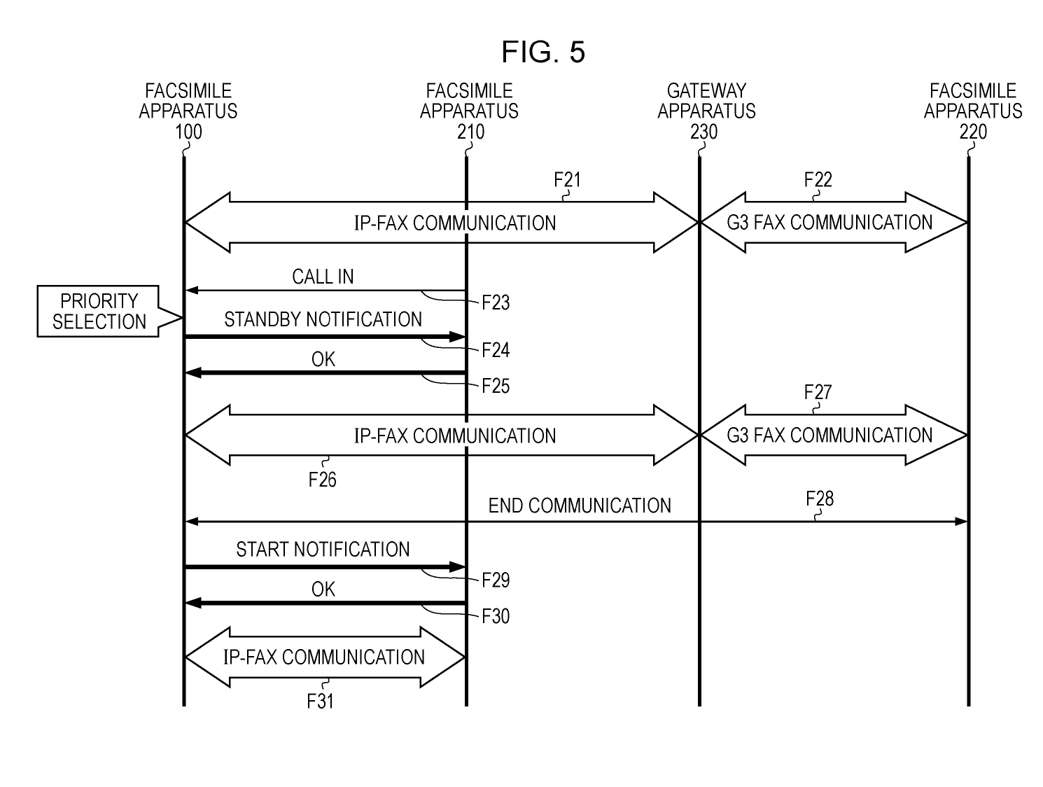

FIG. 5 illustrates a third control operation of the facsimile apparatus 100. The third control operation corresponds to the case where, while the facsimile apparatus 100 is communicating with the facsimile apparatus 220 using the communication path C, the facsimile apparatus 210 originates a call using the communication path A. In FIG. 5, the same components as those illustrated in FIG. 2 are denoted by the same reference numerals. Reference numerals F21 and F31 denote communication steps.

Using the above-mentioned communication path C, the facsimile apparatus 100 is performing IP-FAX communication with the gateway apparatus 230 via the Internet (F21). At the same time, the gateway apparatus 230 is performing G3 FAX communication with the facsimile apparatus 220 (F22). Here, it does not matter whether the communication is transmission from the facsimile apparatus 100 or from the facsimile apparatus 220.

Thereafter, upon receipt of a call (F23) from, for example, a SIP server, the facsimile apparatus 100 analyzes the contents of INVITE information and determines whether the partner apparatus is a gateway apparatus. In the case where it is determined that the partner apparatus is not a gateway apparatus, it can be determined that the apparatus originating the call is connected to the Internet or a LAN, that is, the type 2 communication path is used in this communication.

Based on the determination, the main controller 101 can detect that facsimile communication using the type 1 communication path and facsimile communication using the type 2 communication path are in contention with each other.

Of a plurality of facsimile communication events in contention with one another, the facsimile apparatus 100 selects which facsimile communication event to give priority to. In this case, it is assumed that a priority table indicating that facsimile communication using the type 1 communication path has priority over facsimile communication using the type 2 communication path is set in advance on the RAM 103.

In the case where higher priority is given to facsimile communication using the type 1 communication path, facsimile communication with the facsimile apparatus 220 is performed with priority over facsimile communication with the facsimile apparatus 210.

Specifically in F24, the facsimile apparatus 100 notifies the facsimile apparatus 210 to enter a standby state. When the facsimile apparatus 210 becomes ready to accept the standby notification, the facsimile apparatus 210 sends in F25 an affirmative response (OK) to the facsimile apparatus 100, and communication between the facsimile apparatus 100 and the facsimile apparatus 210 enters a standby state.

The standby notification and its affirmative response (OK) are given by exchanging messages such as a DIS (initial identification) or DCS (reception command) or by exchanging messages such as an NSF or NSS signal.

In F26, the facsimile apparatus 100 performs IP-FAX communication with the gateway apparatus 230. In F27, the gateway apparatus 230 simultaneously performs G3 FAX communication with the facsimile apparatus 220. Here, it does not matter whether the communication is transmission from the facsimile apparatus 100 or from the facsimile apparatus 220.

Accordingly, in the case where the facsimile apparatus 100 is performing facsimile communication with the facsimile apparatus 220, if it becomes necessary for the facsimile apparatus 100 to start facsimile communication with the different facsimile apparatus 210, the facsimile apparatus 100 places the facsimile communication with lower priority on standby. Accordingly, the resources including the main controller 101 and the encoder/decoder 107 can be allocated to the processing for the facsimile communication with higher priority.

In particular, the processing including encoding/decoding of image data for facsimile communication with higher priority can be performed without delay, and hence facsimile communication can be performed without problems.

When the facsimile communication between the facsimile apparatus 100 and the facsimile apparatus 220 ends, the facsimile apparatus 100 and the facsimile apparatus 220 perform facsimile communication termination processing via the gateway apparatus 230 in F28.

That is, the facsimile apparatus 100 and the facsimile apparatus 220 exchange messages such as an EOP (command after the message), MCF (response after the message), DCN (disconnection command), or BYE in the SIP protocol.

Thereafter in step F29, the facsimile apparatus 100 notifies the facsimile apparatus 210 to start the communication. When the facsimile apparatus 210 becomes ready to accept the start notification, the facsimile apparatus 210 sends an affirmative response (OK) in F30 to the facsimile apparatus 100. In F31, the facsimile apparatus 100 and the facsimile apparatus 210 perform the IP-FAX communication.

The start notification and its affirmative response (OK) are given by exchanging messages such as an EOM (Q signal), DIS, or DCS.

According to the third control operation, the description concerns the case where it has been set in advance on the RAM 103 that facsimile communication using the type 1 communication path has higher priority than that of facsimile communication using the type 2 communication path. However, in the case where facsimile communication using the type 2 communication path is given higher priority, a control procedure is performed to place communication with the facsimile apparatus 220 on standby.

That is, for example, a flow control procedure is performed using a TNR signal or an RNR signal, and transmission/reception of image data is placed on standby.

### Operation of Determining Communication Path

A process of determining, by the facsimile apparatus 100, whether a partner apparatus performing IP-FAX communication via the Internet is connected to the public line or connected to the Internet or a LAN will now be described.

A first determination method involves registering information regarding a partner apparatus in an internal memory (e.g., the RAM 103) of the facsimile apparatus 100.

That is, in the case where each partner apparatus' phone number to originate a call thereto, IP address, and the like are registered, attribute information indicating whether the partner apparatus is connected to the public line or connected to the Internet or a LAN is registered.

This enables the determination of the type of partner apparatus based on the destination information used by the facsimile apparatus 100 to originate a call or sender information sent from the partner apparatus when a call from the partner apparatus is accepted. It therefore becomes possible to determine whether the communication is facsimile communication using the above-mentioned type 1 communication path or facsimile communication using the type 2 communication path. Based on the determination result, whether facsimile communication using the type 1 communication path and facsimile communication using the type 2 communication path are in contention with each other can be detected.

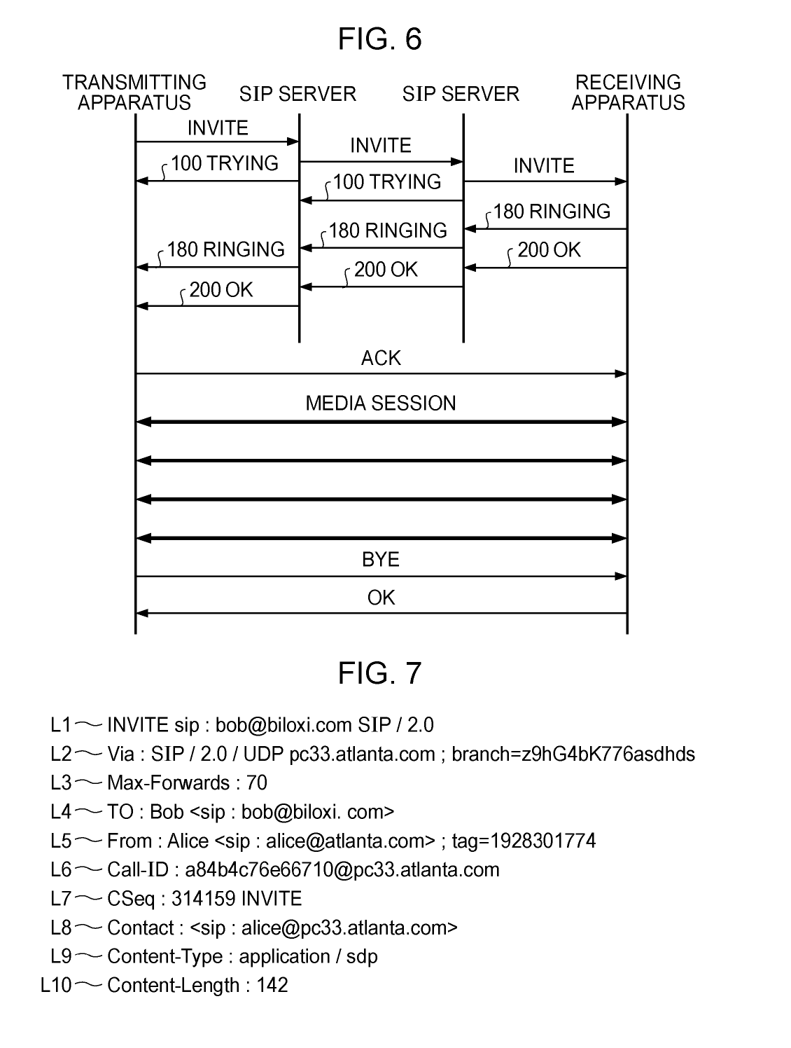

A second determination method involves using INVITE message information in compliance with the SIP protocol. FIG. 6 illustrates a communication procedure performed by the facsimile apparatus 100 using the SIP protocol. In this case, a call is connected between a transmitting apparatus and a receiving apparatus using SIP servers in compliance with the SIP protocol.

Referring to FIG. 6, the transmitting apparatus sends an INVITE message via its SIP server, and the receiving apparatus sends an affirmative message (OK) via its SIP server, thereby connecting a call (session) therebetween. Messages correspond not to the same session, but to different, individual sessions. The call-ID written in each message keeps the relationship between the message and its session. In the case where an acknowledgement (ACK) message is directly sent from the calling side and received by the receiving side, a media session is performed. In this case, the media session is IP-FAX communication in compliance with the ITU-T Recommendation T.38. When the media session ends, BYE and OK messages are sent and received to break the call (session).

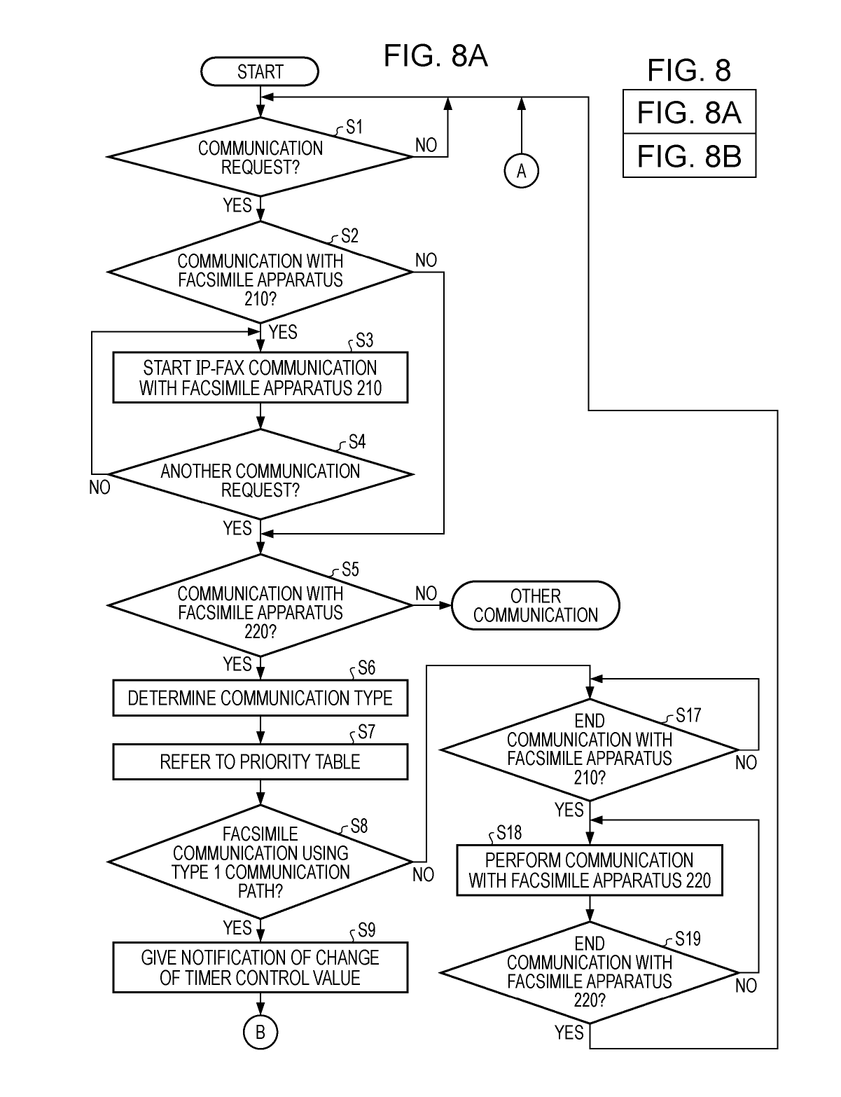

FIG. 7 illustrates the contents of an INVITE message received by the facsimile apparatus 100. Referring to FIG. 7, it can be identified that “From: Alice <sip: alice@atlanta.com>; . . . ” on line 5 indicates the partner originating the INVITE message.

Based on the partner information, the main controller 101 can determine whether the apparatus originating the call is a facsimile apparatus or a gateway apparatus.

More specifically, information for specifying a gateway apparatus is registered on the RAM 103 of the facsimile apparatus. When an INVITE message arrives, a determination is made by referring to the information registered.

Further, information for specifying the gateway apparatus 230 may be registered in a memory. Upon receipt of an INVITE message from the gateway apparatus 230, it may be determined that the facsimile communication uses the type 1 communication path.

Also, information for specifying the facsimile apparatus 210 may be registered. Upon receipt of an INVITE message from the facsimile apparatus 210, it may be determined that the facsimile communication uses the type 2 communication path.

A third determination method involves determining the type of partner apparatus performing facsimile communication via the Internet during a facsimile communication procedure. In this case, a message such as a DIS, DCS, NSF, or NSS is used, and apparatus type information is inserted in a field of the message. Upon receipt of the information, the facsimile apparatus 100 can make a determination.

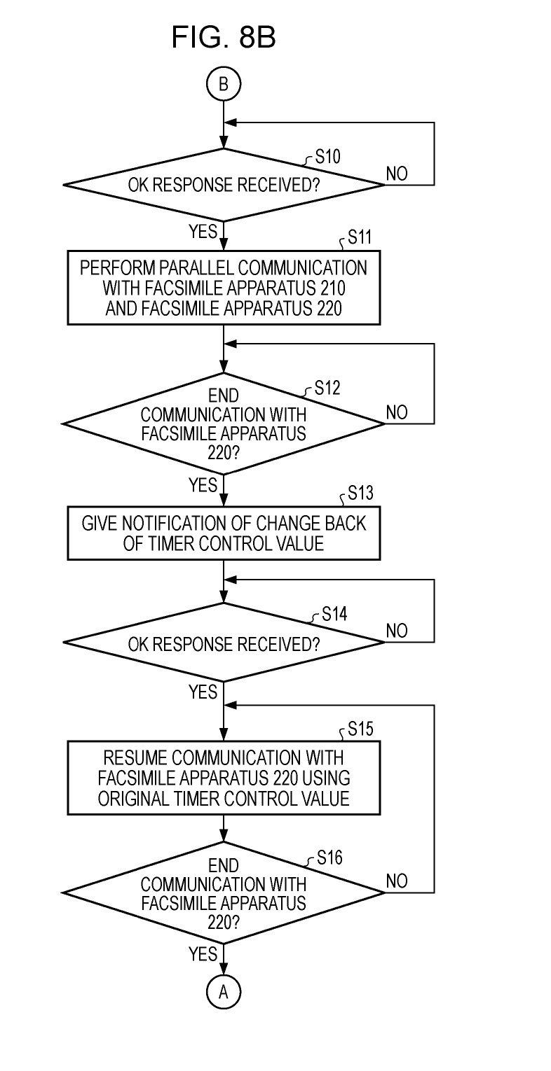

FIGS. 8A and 8B are flowcharts of a series of control operations including the above-described first to third control operations of the facsimile apparatus 100.

This series of operations corresponds to an exemplary communication process in which, while the facsimile apparatus 100 is communicating with the facsimile apparatus 210, the facsimile apparatus 100 performs communication with the facsimile apparatus 220 via the gateway apparatus 230 in parallel.

Reference numerals S1 to S19 denote respective steps, and these steps are performed by loading a communication control program stored on the ROM 102 onto the RAM 103 and executing the program by the main controller 101. 0132 In step S1, the facsimile apparatus 100 monitors whether a communication request is received. Upon receipt of a communication request, the main controller 101 determines in step S2 whether the apparatus issuing the communication request is the facsimile apparatus 210 based on the communication protocol. In the case where the main controller 101 determines that the apparatus is not the facsimile apparatus 210, the flow proceeds to step S5.

In contrast, in the case where the main controller 101 determines that the communication request has been issued from the facsimile apparatus 210, flow proceeds to step S3, where the main controller 101 of the facsimile apparatus 100 directly performs IP-FAX communication with the facsimile apparatus 210 via the Internet, as in the communication path A described above. In this case, it does not matter whether the communication is transmission from the facsimile apparatus 100 or from the facsimile apparatus 210. It is regarded that the timer control value is set to a normal value (TM1) in F1 shown in FIG. 3.

Thereafter in step S4, while the facsimile apparatus 100 is communicating with the facsimile apparatus 210 via the network I/F 108, the main controller 101 determines whether another communication request has been issued via the network I/F 108. In the case where it is determined that no other communication request has been issued, the flow returns to step S3.

In contrast, in the case where the main controller 101 determines that another communication request has been issued via the network I/F 108, the main controller 101 determines in step S5 whether the apparatus issuing the communication request is the facsimile apparatus 220 connected thereto via the gateway apparatus 230.

In the case where it is determined that the apparatus is not the facsimile apparatus 220 connected to the facsimile apparatus 100 via the gateway apparatus 230, other communication is performed. The main controller 101 performs start processing of facsimile communication including IP-FAX communication and G3 FAX communication with the facsimile apparatus 220 via the gateway apparatus 230.

In contrast, in the case where the main controller 101 determines in step S5 that the communication is with the facsimile apparatus 220 connected thereto via the gateway apparatus 230, the main controller 101 determines the communication type based on the protocol in step S6.

Next, the main controller 101 of the facsimile apparatus 100 performs priority determination processing for realizing simultaneous communication. In step S7, the main controller 101 refers to the priority table stored on the RAM 103 and determines which of facsimile communication using the type 1 communication path and facsimile communication using the type 2 communication path is given higher priority.

In the case where the main controller 101 determines that facsimile communication using the type 1 communication path is given higher priority (Yes in S8), the main controller 101 of the facsimile apparatus 100 controls and notifies in step S9 the facsimile apparatus 210 to change the timer control value.

In the case where the main controller 101 determines in step S8 that facsimile communication using the type 1 communication path is given lower priority (No in step S8), the main controller 101 monitors termination of communication with the facsimile apparatus 210 in step S17.

At this time, communication with the facsimile apparatus 220 is on standby. When communication with the facsimile apparatus 210 is terminated, the main controller 101 of the facsimile apparatus 100 performs communication with the facsimile apparatus 220 via the gateway apparatus 230 in step S18. In step S19, the main controller 101 monitors termination of communication with the facsimile apparatus 220. When communication with the facsimile apparatus 220 is terminated (Yes in S19), the flow returns to step S1.

In contrast, in step S10, the main controller 101 monitors reception of an affirmative response (OK) from the facsimile apparatus 210 in response to the timer-control-value change notification given from the facsimile apparatus 100 in step S9.

Upon receipt of an affirmative response (OK) from the facsimile apparatus 210 (Yes in S10), the facsimile apparatus 100 performs IP-FAX communication with the facsimile apparatus 220 in a state in which the timer control value is changed to TM2.

In this case, the timer control value TM2 is greater than the normal timer control value TM1 in IP-FAX communication (TM1<TM2).

In step S11, the facsimile apparatus 100 communicates with the gateway apparatus 230 in order to communicate with the facsimile apparatus 220 in parallel to communication with the facsimile apparatus 210.

In step S12, the facsimile apparatus 100 monitors termination of facsimile communication with the facsimile apparatus 220. When facsimile communication with the facsimile apparatus 220 is terminated, the facsimile apparatus 100 and the facsimile apparatus 220 perform termination processing of facsimile communication via the gateway apparatus 230.

That is, the facsimile apparatus 100 and the facsimile apparatus 220 exchange messages such as an EOP (command after the message), MCF (response after the message), DCN (disconnection command), or BYE in the SIP protocol.

Thereafter in step S13, the main controller 101 of the facsimile apparatus 100 notifies the facsimile apparatus 210 to change the timer control value back to the normal value.

When the facsimile apparatus 210 becomes ready to accept the change of the timer control value, the facsimile apparatus 210 sends an affirmative response (OK) to the facsimile apparatus 100. Upon receipt of the affirmative response (OK) in step S14, the facsimile apparatus 100 and the facsimile apparatus 210 change the timer control value to TM1 and resumes IP-FAX communication in step S15.

Accordingly, in the case where the facsimile apparatus 100 simultaneously performs IP-FAX communication and G3 FAX communication with a plurality of apparatuses, a reduction in the performance and a communication break due to an increase in the internal processing of the facsimile apparatus 100 can be avoided.

In step S16, the main controller 101 determines whether the normal data communication with the facsimile apparatus 210 has been terminated. In the case where the main controller 101 determines that the normal data communication with the facsimile apparatus 210 has not been terminated, the flow returns to step S15. In the case where it is determined that the normal data communication with the facsimile apparatus 210 has been terminated, the flow returns to step S1, and the main controller 101 waits for the next data communication request.

As has been described in the second control operation, the processing in step S9 may be changed to data-communication standby notification processing, etc., and the processing in step S13 may be changed to data-communication start notification processing.

In the above-described first embodiment, the case in which the user can select and set in advance which of facsimile communication using the type 1 communication path and facsimile communication using the type 2 communication path should be given higher priority in the priority table stored on the RAM 103 of the main controller 101 has been described.

However, the preset priority may need to be changed depending on the network connection environment or the user's communication environment. In which case, the priority set in the priority table should be rewritable. Further, rewriting the priority set in the priority table can be done dynamically by monitoring a history of communication with other data communication apparatuses in the course of time.

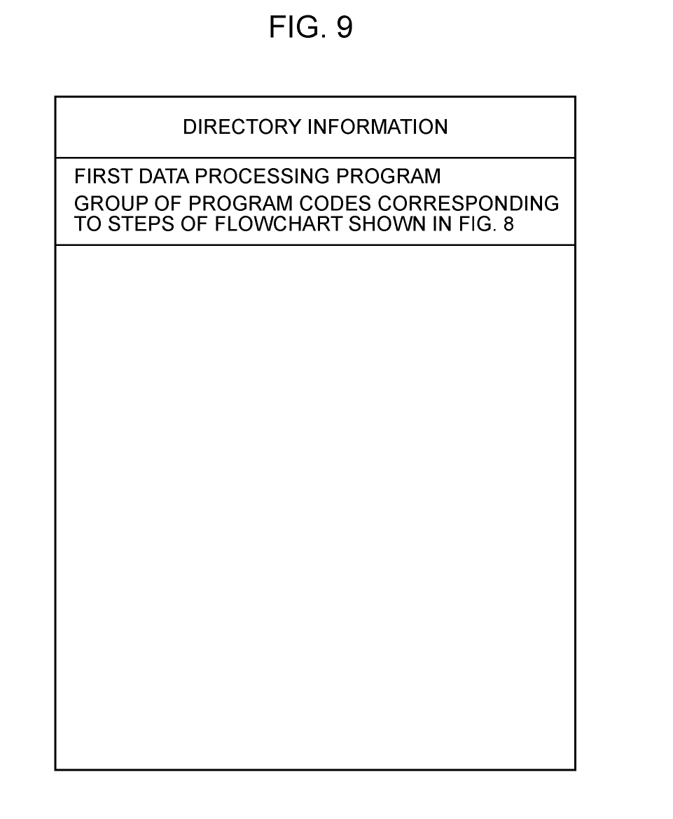

The structure of data processing programs readable by a facsimile apparatus according to a third exemplary embodiment of the present invention will be described with reference to a memory map illustrated in FIG. 9.

FIG. 9 illustrates the memory map of a storage medium storing various data processing programs that can be read by the facsimile apparatus according to the present embodiment of the present invention.

Although not illustrated in FIG. 9, information for managing a group of programs stored on the storage medium, such as version information and creator information, may also be stored, and information depending on an operating system (OS) of a program reader, such as icons for indicating the programs in a distinguishable manner, may also be stored.

Further, data belonging to the foregoing programs is also managed in the same directory. Programs for installing the foregoing programs or, in the case where the programs to be installed are compressed, programs for decompressing the compressed programs may also be stored.

The functions illustrated in FIG. 8 according to the first embodiment of the present invention may be executed by a host computer using a program installed from an external source. In this case, the present invention is applicable even in the case where information group including the programs is supplied from a storage medium such as a compact-disc read-only memory (CD-ROM), a flash memory, or a floppy disk (FD), or from an external storage medium via a network to an output apparatus.

As has been described, the present invention may be implemented by providing a storage medium that stores program codes of software for executing the functions of the above-described embodiments to a system or an apparatus and by causing a computer (or a CPU or a microprocessing unit (MPU)) of the system or apparatus to read and execute the program codes stored on the storage medium.

In this case, the program codes read from the storage medium implement a new function of the present invention, and the storage medium that stores the program codes constitutes an embodiment of the present invention.

Any program form including the functionality of programs, such as an object code, a program executed by an interpreter, or script data supplied to an OS, may be used.

Storage media for supplying the programs may include, for example, a floppy disk, a hard disk, an optical disk, a magneto-optical (MO) disk, a CD-ROM, a compact-disc recordable (CD-R), a compact-disc rewritable (CD-RW), a magnetic tape, a non-volatile memory card, a ROM, and a digital versatile disk (DVD).

In this case, the program codes read from the storage medium implement the functions of the embodiments, and the storage medium that stores the program codes constitutes an embodiment of the present invention.

The programs may also be supplied by accessing a homepage on the Internet using a browser of a client computer and downloading a computer program of the present invention or a file having the compressed version of the program and an automatic installation function from the homepage to a recording medium, such as a hard disk. The program codes constituting the programs of the present invention may be divided into a plurality of files, and the files may be individually downloaded from different homepages. Thus, a world wide web (WWW) server or a file transfer protocol (FTP) server that allows a plurality of users to download a program file implementing a function of the present invention on a computer may also fall within the scope of the present invention.

The programs of the present invention may be encrypted and stored on a storage medium, such as a CD-ROM, and the storage medium may be distributed to a user. A user who satisfies a predetermined condition may be allowed to download key information for decryption from a homepage via the Internet and to decrypt the encrypted programs using the key information, which are then installed into a computer for execution.

Functions of the above-described embodiments may be implemented not only by executing the program codes read by a computer but also by performing a portion of or the entirety of actual processing by an OS or the like running on the computer according to instructions of the program codes.

Functions of the above-described embodiments may also be implemented by writing the program codes read from the storage medium to a memory of a function expansion board inserted into the computer or a function expansion unit connected to the computer and then performing a portion of or the entirety of actual processing by a CPU or the like of the function expansion board or the function expansion unit according to instructions of the program codes.

The present invention is not limited to the above-described embodiments, and a variety of changes including an organic combination of the embodiments may be made according to the present invention. These changes may also fall within the scope of the present invention.

While the present invention has been described in the context of various examples and embodiments, it is anticipated by those skilled in the art that the spirit and scope of the present invention are not limited to a specific description of this specification.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-315450 filed Nov. 22, 2006, which is hereby incorporated by reference herein in its entirety.

What is claimed is:

1. A facsimile apparatus comprising:
a communication unit configured to perform facsimile communication with at least one partner apparatus using a first communication path including a public line or a second communication path not including the public line;
a detection unit configured to detect whether facsimile communication using the first communication path and facsimile communication using the second communication path are in contention with each other;
a selection unit configured to select which of facsimile communication using the first communication path and facsimile communication using the second communication path is to be given priority in a case where the detection unit detects that facsimile communication using the first communication path and facsimile communication using the second communication path are in contention with each other; and
a control unit configured to control and give priority to facsimile communication selected by the selection unit.

2. The facsimile apparatus according to claim 1, further comprising a processing unit configured to process data for use in facsimile communication performed by the communication unit,
wherein the control unit is configured to control the processing unit so that data for use in facsimile communication selected by the selection unit is processed with priority.

3. The facsimile apparatus according to claim 1, wherein, in a case where facsimile communication using the first communication path is selected by the selection unit, the control unit changes a timer control value of facsimile communication using the second communication path.

4. The facsimile apparatus according to claim 1, wherein the control unit is configured to perform, with priority, facsimile communication selected by the selection unit by placing facsimile communication not selected by the selection unit on standby.

5. The facsimile apparatus according to claim 1, wherein the first communication path includes the public line and the Internet or a local area network.

6. The facsimile apparatus according to claim 1, wherein the second communication path includes the Internet or a local area network.

7. The facsimile apparatus according to claim 1, wherein the communication unit is configured to perform real-time Internet facsimile communication via the Internet or a local area network, and
wherein the detection unit is configured to detect that facsimile communication using the first communication path and facsimile communication using the second communication path are in contention with each other by determining whether each of the at least one partner apparatus with which real-time Internet facsimile communication is performed in parallel by the communication unit is connected to the public line or connected to the Internet or a local area network.

8. A facsimile apparatus comprising:
a communication unit configured to perform facsimile communication with at least one partner apparatus;
a determination unit configured to determine whether the at least one partner apparatus is connected to a public line or connected to the Internet or a local area network;
a detection unit configured to detect, based on a determination result obtained by the determination unit, whether facsimile communication performed with a partner apparatus connected to the public line and facsimile communication performed with a partner apparatus connected to the Internet or a local area network are in contention with each other; and
a control unit configured to control and give priority to facsimile communication performed with the partner apparatus connected to the public line in a case where the detection unit detects that facsimile communication performed with the partner apparatus connected to the public line and facsimile communication performed with the partner apparatus connected to the Internet or the local area network are in contention with each other.

9. The facsimile apparatus according to claim 8, further comprising a processing unit configured to process data for use in facsimile communication performed by the communication unit,
wherein the control unit controls the processing unit to process, with priority, data for use in facsimile communication performed with the partner apparatus connected to the public line.

10. The facsimile apparatus according to claim 8, wherein the control unit is configured to change a timer control value of facsimile communication performed with the partner apparatus connected to the Internet or the local area network.

11. The facsimile apparatus according to claim 8, wherein facsimile communication performed by the communication unit is real-time Internet facsimile communication.

12. A method for controlling a facsimile apparatus, the method comprising:
performing facsimile communication with at least one partner apparatus using a first communication path including a public line or a second communication path not including the public line;
detecting whether facsimile communication using the first communication path and facsimile communication using the second communication path are in contention with each other;
selecting which of facsimile communication using the first communication path and facsimile communication using the second communication path is to be given priority in a case where the detection unit detects that facsimile communication using the first communication path and facsimile communication using the second communication path are in contention with each other; and
controlling and giving priority to facsimile communication selected from facsimile communication using the first communication path and facsimile communication using the second communication path.

13. A method for controlling a facsimile apparatus, the method comprising:
performing facsimile communication with at least one partner apparatus;
determining whether the at least one partner apparatus is connected to a public line or connected to the Internet or a local area network;
detecting, based on a determination result, whether facsimile communication performed with a partner apparatus connected to the public line and facsimile communication performed with the Internet or a local area network are in contention with each other; and
controlling and giving priority to facsimile communication performed with the partner apparatus connected to the public line in a case where it is detected that facsimile communication performed with the partner apparatus connected to the public line and facsimile communication performed with the partner apparatus connected to the Internet or the local area network are in contention with each other.
